(19) United States
(12) Patent Application Publication
(10) Pub. No.: US 2005/0276478 A1
(43) Pub. Date: Dec. 15, 2005

(54) Pattern identification apparatus

(76) Inventors: Kun-Lang Yu, Keelung (TW); Ching-Fuh Lin, Taipei Hsien (TW); Andy Cheng, Taipei (TW)

Correspondence Address: BIRCH STEWART KOLASCH & BIRCH, PO BOX 747, FALLS CHURCH, VA, 22040-0747, US

(21) Appl. No.: 10/864,330

(22) Filed: Jun. 10, 2004

(51) Int. Cl. G06K 9/00; H04K 1/00

(52) U.S. Cl. 382/181; 705/67

(57) ABSTRACT

A pattern identification system includes a platform, a conveying device, an illumination device, a video camera unit, a controller, a programmable identification member and a switching member. The conveying device transports a feeding sample sheet on the platform mounted in the pattern identification apparatus. The illumination device projects light on the sample sheet. The controller controls the video camera to magnify an image with a predetermined multiple sufficient for identification at the predetermined position of the sample pattern so as to allow capturing an identifiable image of difference with respect to a programmed feature. The identifiable image of the selected pattern is captured and sent to the programmable identification member for identifying the selected pattern of the sample sheet. After identifying, the switching member is switched for outputting and sorting the sample sheet by the controller in response to a control signal of the programmable identification member.

### BACKGROUND OF THE INVENTION

1. Field of the Invention

The present invention relates to a pattern identification apparatus. More particularly, the present invention relates to the pattern identification apparatus for processing and identifying an image of a pattern with a predetermined magnification to prevent from a fraud pattern.

2. Description of the Related Art

Currently, computer color printing has been continuously progressed that encourages to widely spread forging and copies. Since the forging and copies of various patterns cannot be identified, counterfeits of identification, valuable paper and currency can easily conduct vision of civilians to confusion and failure in recognition. In addition to failure in recognition, eyes of identifiers cannot speed up recognition with thousands of articles. Hence, there is a need for a pattern identification system or device to recognize the counterfeits of identification, valuable paper and currency.

Taiwanese Patent Publication No. 490054, published on Jun. 1, 2002, discloses an anti-counterfeit machine for currency. The anti-counterfeit machine has a sensor system for measuring and checking security features (such as bidden number) of banknotes. The anti-counterfeit machine employs a three-D scanning camera which captures an image of hidden number of notes and identifies it as a real or fake one.

However, the anti-counterfeit machine of No.490054 for checking hidden number of banknotes must be limited by various design choices (such as patterns and printing lines of banknote) and types (specifications of nations and sizes) of banknotes. Once a version of the banknotes is corrected, the anti-counterfeit for the former banknotes cannot her be used that results in an increase of manufacturing cost for a replacement. Furthermore, there are two drawbacks for measuring an image of printing lines of hidden numbers. First, after using over a long time, printing lines of the banknotes may be faded out specific that results in failure in recognition. Second, outer light, UV beam or detection light for raised ink may affect operation of the three-D scanning camera of the anti-counterfeit machine that results in a reduced percentage of accuracy in recognition.

Generally, a public document or a certificate may not provide with particular security features, However, the anti-counterfeit machine of No.490054 is suitable for checking security features (such as raised ink, relief printing, security thread, iridescent shifting ink, fluorescence pattern and laser pattern) of banknotes and valuable papers, but unsuitable for checking an embossing stamp pressed on a graduation certificate or a birth certificate. As a result, it is inconvenient for recognition only with the embossing stamp of the graduation certificate or the birth certificate.

With regard to iridescent shifting ink or fluorescence filament, it is easy to counterfeit or forge and uneasy to identify it in vision. Using a counterfeit detection device, there is a possibility of failure in recognition of iridescent shifting ink and fluorescence filament which may be faded out and abraded resulting from a long-term use.

In fact, banknotes, valuable papers, public documents and certificates have common features of printing, spectra and fibers that are adequate to identify features for recognition. Although computer color printing and copy have been continuously progressed, common features of printing, spectra and fibers cannot be forged and copied, namely, the common features between true and false are distinguishable. Accordingly, lie features of general public documents and certificates are adequate to be identified without providing with security features. Credit cards, banknotes and valuable papers with security features still have common features of printing, spectra and fibers are adequate to be identified.

Simply, there is no need for identifying a security feature of forges and copies but only a need for necessarily identifying features of printing, spectra and fibers.

Applicant's own. U.S. Pat. Application. No. 10/689,055, filed on Oct. 21, 2003, discloses a pattern identification system to identify features of printing, spectra and fibers of an image captured from a predetermined point of a pattern. The pattern identification system is able to process and identify the image of the pattern with a predetermined magnification. However, there is a need for an identification mechanism or apparatus which can operate to identify the image of the pattern with a predetermined magnification.

The present invention intends to provide a pattern identification apparatus which is used to identify features of printing, spectra and fibers of an image captured from a predetermined point of a pattern. The pattern identification is able to process and identify the image of the pattern with a predetermined magnification in such a way to mitigate and overcome the above problem.

### SUMMARY OF THE INVENTION

The primary objective of this invention is to provide a pattern identification apparatus to identify features of printing, spectra and fibers of an image, captured from a predetermined point of a sample pattern, by sufficiently magnifying it to obtain an identifiable image of difference with respect to a programmed feature. Thereby, the pattern identification apparatus can carry out mechanical operation of identification and improve the identification process.

The secondary objective of this invention is to provide a pattern identification apparatus to identify features of printing, spectra and fibers of an image, captured from a predetermined point of a sample pattern, without a process for comparing it with a reference image. Thereby, the pattern identification apparatus can carry out mechanical operation of identification and simplify the identification process.

The pattern identification apparatus in accordance with the present invention includes a platform, a conveying device, an illumination device, a video camera unit (containing a controllable camera lens), a controller, a programmable identification member and a switching member. The conveying device transports a feeding sample sheet on the platform mounted in the pattern identification apparatus. The illumination device projects light on a selected pattern of the sample sheet. A power device drives the video camera unit to move to a predetermined position of the sample sheet by the controller. The controller controls the video camera to magnify an image with a predetermined magnification sufficient for identification at the predetermined position of the sample pattern so as to allow capturing an identifiable image of difference with respect to a programmed feature. The identifiable image of the selected pattern is captured and sent to the programmable identification member for identifying the selected pattern of the sample sheet. After identifying, the switching member is switched to a predetermined outputting position for outputting and sorting the sample sheet by the controller in response to a control signal of the programmable identification member.

Another embodiment of the present invention is a pattern identification apparatus includes a feeding roller set and a band conveyer. The feeding roller set is adapted to separately feed the sample sheet into the pattern identification apparatus. The band conveyer employs a power element to transmit the sample sheet to a predetermined position in the pattern identification apparatus and then to output it from the pattern identification apparatus according to the control signal of the programmable identification member.

Another embodiment of the present invention is a pattern identification apparatus comprising an illumination device which projects a particular wavelength and brightness of light on the sample sheet according to classification of characteristics of the sample sheet.

Another embodiment of the present invention is a pattern identification apparatus comprising a video camera unit adapted to measure a reference coordinate of the sample sheet and capture an image for identification.

Another embodiment of the present invention is a pattern identification apparatus comprising an illumination device consisting of illuminants which are separately disposed above and below a platform. The illuminants project a particular wavelength and brightness of light on the sample sheet to allow a video camera unit capturing a front image and a rear image of the sample sheet.

Another embodiment of the present invention is a pattern identification apparatus comprising a track adapted to transport the illumination device and the video camera unit.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is a block diagram of a pattern identification apparatus in accordance with a preferred embodiment of the present invention;

FIG. 2 is a cross-sectional view of the pattern identification apparatus in accordance with the preferred embodiment of the present invention;

FIG. 3 is a top view of the pattern identification apparatus in accordance with a second embodiment of the present invention;

FIG. 4 is a cross-sectional view of the pattern identification apparatus, similar to FIG. 2, operating a switch member in switching operation in accordance with the preferred embodiment of the present invention; and

FIG. 5 is a flow chart of the pattern identification apparatus in accordance with the preferred embodiment of the present invention.

### DETAILED DESCRIPTION OF THE INVENTION

The term “motor,” defined in the present invention, includes an ac motor, a dc motor and a stepping motor etc. The term “video camera unit,” defined in the present invention, includes a single camera lens or at least two camera lenses, and does not exclude any type and specification of modem camera devices, such as a CCD (Charge-Coupled Device), The term “controller,” defined in the present invention, pertains to a control logical circuit, a control IC or a CPU (Central Processing Unit). And, the term “programmable identification member,” defined in the present invention., pertains to an identification logical circuit or an identification database of a computer software.

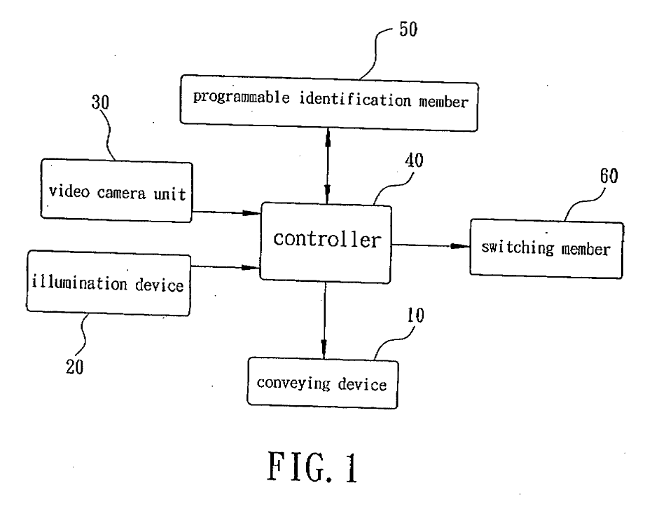

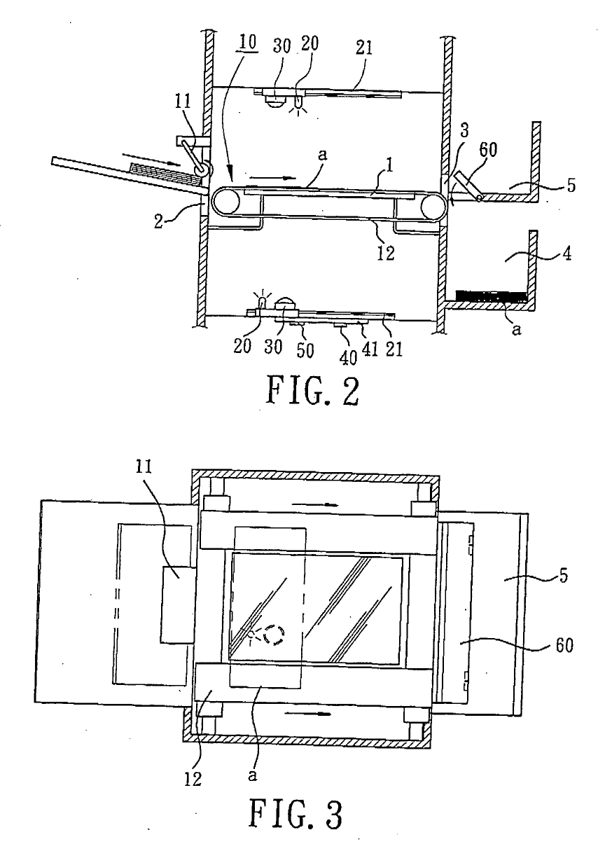

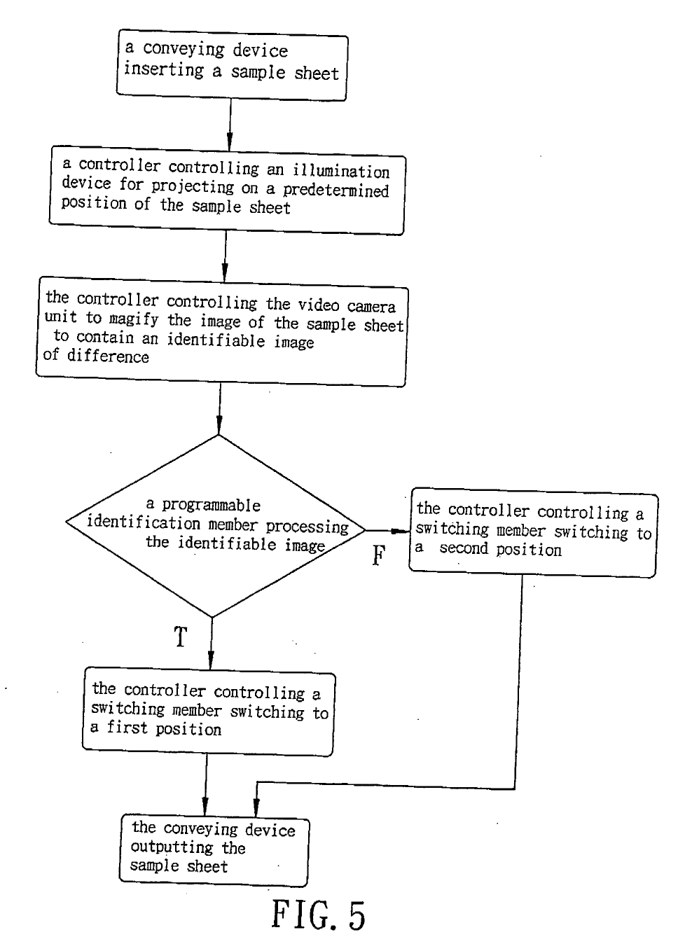

FIG. 1 illustrates a block diagram of a pattern identification apparatus in accordance with the preferred embodiment of the present invention; FIGS. 2 through 4 illustrate the pattern identification apparatus in accordance with the preferred embodiment of the present invention; and FIG. 5 illustrates a flow chart of the pattern identification apparatus in accordance with the preferred embodiment of the present invention,.

Referring initially to FIG. 1, the pattern identification apparatus in accordance with the preferred embodiment of the present invention includes a conveying device 10, a pair of illumination devices 20, a pair of video camera units 30, a controller 40, a programmable identification member 50 and a switching member 60. The controller 40 is electrically connected with the conveying device 10, the illumination devices 20, the video camera units 30, the programmable identification member 50 and the switching member 60.

Turning now to FIGS. 2 and 3, the pattern identification apparatus is provided with a platform 1, an inlet 2, an outlet 3, a first collecting tray 4 and a second collecting tray 5. The platform 1 forms a transparent plate adapted to support a sample sheet (a) so that an image of the underside of the sample sheet (a) can be observed or captured. The conveying device 10 is disposed along the platform 1 so as to allow the sample sheet (a) passing through the platform 1. The conveying device 10 consists of a feeding roller set 11 and a band conveyer 12. The feeding roller set 11 is a dynamic roller which has an end in contact with the sample sheet (a) and can be adjusted orientation in feeding in response to changes in quantities and total thickness of the sample sheets (a). In operation, the feeding roller set 11 is employed to individually feed the sample sheets (a) into the inlet 2. The band conveyer 12 is provided with a roller set and a power element so that the band conveyer 12 is running between the inlet 2 and the outlet 3 for transporting the sample sheet (a) to a predetermined position on the platform 1. At this time, the illumination devices 20 and the video camera units 30 are actuated to capture an image of the sample sheet (a) and subsequently sent it to the programmable identification member 50 for operating an identification process. Finally, the sample sheet (a) is output to the outlet 3 according to the result of the identification of the programmable identification member 50.

Referring again to FIGS. 2 and 3, the illumination device 20 includes a LED or a laser illuminator which can generate particular wavelength selected from a group consisting of red, green, blue, infrared, ultraviolet etc. The video camera unit 20 includes an optical amplifier (not shown) adapted to magnify an image of a sample pattern with a predetermined magnifying multiple sufficient for identification and to capture an image of the sample pattern.

Still referring to FIGS. 2 and 3, there are two combination sets of the illumination devices 20 and the video camera units 30 and selectively disposed above and below the platform 1. Each combination set is assembled on a track 21 so that a power element (not shown) can drive the illumination devices 20 and the video camera units 30 along the track 21 according to control signals outputting from the controller 40. The moving scope of the illumination devices 20 and the video camera units 30 is limited within the platform 1.

Referring back to FIGS. 1 and 2, the controller 40 and the programmable identification member 50 are mechanically mounted and electrically connected to a substrate 41. After the video camera unit 30 magnifies the image of the sample sheet (a) with a magnifying multiple sufficient for identification, the video camera unit 30 is able to capture an identifiable image of difference with respect to a programmed feature. Subsequently, the controller 40 connected to the programmable identification member 50 and sent the identifiable image thereto. The programmable identification member 50 is used to process identification for the identifiable image of the sample sheet (a). After processing identification operation, the sample sheet (a) is outputted to the outlet 3 by controlling the switching member 60.

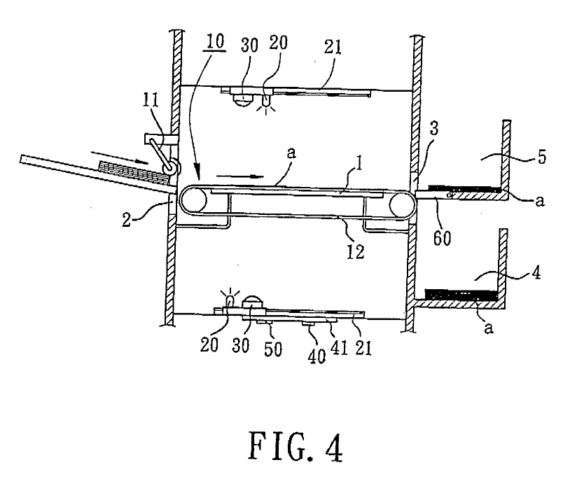

Turning now to FIGS. 2 and 4, the switching member 60 forms a thin plate located at the outlet 3 and pivotally connected thereto. In operation, the switching member 60 is able to switch between the first collecting tray 4 and the second collecting tray 5 according to the identification of the programmable identification member 50. Consequently, Once the identification process of the programmable identification member 50 is completed, the sample sheet (a) is output to either of the first collecting tray 4 or the second collecting tray 5.

Referring back to FIGS. 2 and 4, when the programmable identification member 50 determines the true of the sample sheet (a), the switching member 60 may close the second collecting tray 5. As best shown in. FIG. 2, the switching member 60 may also open the first collecting tray 4 and regards it as a receiving tray for separating and collecting the true of the sample sheet (a). Contrarily, when the programmable identification member 50 determines the false (counterfeit) of the sample sheet (a), the switching member 60 may close the first collecting tray 4. As best shown in FIG. 4, the switching member 60 may also open the second collecting tray 5 and regards it as a receiving tray for separating and collecting the false of the sample sheet (a).

Turning now to FIG. 5, it illustrates six processing steps essentially consisting of the automatically operating process and the identification process.

Referring again to FIGS. 2, 4 and 5, the sample sheet (a) is initially inserted into the inlet 2 of the pattern identification apparatus in accordance with the preferred embodiment of the present invention. The feeding roller set 11 is employed to individually feed the sample sheets (a) into the inlet 2 of the pattern identification apparatus and individually actuates from the top of the sample sheets (a) to its bottom. When the feeding roller set 11 fed one of the sample sheets (a), the conveying device 10 may immediately pause in operation. Once the sample sheets (a) is inserted into the inlet 2, the band conveyer 12 may transport it to a predetermined position on the platform 1. Consequently, the illumination devices 20 and the video camera units 30 can project on the sample sheet (a) from above and below the platform 1. At this time, the band conveyer 12 of the conveying device 10 is paused and completely positioned the sample sheet (a) at the predetermined position of the platform 1 so as to operate following process.

Subsequently, the controller 40 controls to move the illumination device 20 and the video camera unit 30 to the predetermined position with respect to the sample sheet (a). After that the illumination device 20 projects a particular wavelength and brightness of light on the sample sheet (a) and selects a predetermined position of the sample sheet (a) for capturing an image.

The video camera unit 30 includes a controllable camera lens which is used to magnify an image of the sample sheet (a) with a predetermined magnifying multiples to provide an identifiable image of difference and then to capture the identifiable image. And, the identifiable image is adapted to send to the programmable identification member 50 for an identification process.

Subsequently, the controller 40 controls the video camera unit 30 to send the identifiable image to the programmable identification member 50 for an identification process. The programmable identification member 40 is able to identify features of printing, spectra and fibers. The identifiable image of the sample sheet (a) consists of the above-mentioned features of printing, spectra and fibers. The programmable identification member 50 has a recognizing logic adapted to process the identifiable image so as to generate a difference between the identifiable image and the recognizing logic, and output an identification result. In the identification operation, the programmable identification member 50 can be selected from a recognizing logic of computer software for identifying true or false. The present invention employs unique features of printing, spectra and fibers that are adequate to identify features for recognition. However, the unique printing features include printing line structure, raised ink, pattern structure, printing color, fiber property, fiber component and fiber density etc. and can be identified.

Subsequently, the controller 40 controls the switching member 60 according to the identification result outputting from the programmable identification member 50 that the switching member 60 switches between the first collecting tray 4 and the second collecting tray 5. When the identification result is true, the switching member 60 closes the second collecting tray 5 and opens the first collecting tray 4, as best shown in FIG. 2. Contrarily, when the identification result is false, the switching member 60 closes the first collecting tray 4 and opens the second collecting tray 5, as best shown in FIG. 4.

Finally, the controller 40 controls the conveying device 10 to operate the band conveyer 12 that transports the sample sheet (a) for outputting from the outlet 3. When the identification result is true, the switching member 60 may open the first collecting tray 4 that the true sample sheets (a) are piled up in the collecting tray 4, as best shown in FIG. 2. Contrarily, when the identification result is false, the switching member 60 may open the second collecting tray 5 that the false sample sheet (a) are piled up in the collecting tray 5, as best shown in FIG. 4. Preferably, the controller 40 further connects to an alarm device (not shown) for alarming the false sample sheet (a) to notify a user.

Although the invention has been described in detail with reference to its presently preferred embodiment, it will be understood by one of ordinary skill in the art that various modifications can be made without departing from the spirit and the scope of the invention, as set forth in the appended claims.

1. A pattern identification apparatus, comprising:
a platform adapted to support a sample sheet;
at least one illumination device adapted to project light on the sample sheet;
at least one video camera unit adapted to magnify an image of the sample sheet with a predetermined magnifying mulitple to obtain an identifiable image of difference sufficient for identification;
a controller connected to the illumination device to turn it on or off, the controller further connected to the video camera unit to capture the identifiable image of the sample pattern; and
a programmable identification member connected to the video camera unit and the controller, the programmable identification member including a recognizing logic adapted to process the identifiable image so as to generate a difference between the identifiable image and the recognizing logic, and the programmable identification member adapted to identify the identifiable image outputted from the video camera unit;
wherein the controller controls the video camera unit to output the identifiable image to the programmable identification member for identification.

2. The pattern identification apparatus as defined in claim 1, further comprising a conveying device including a band conveyer adapted to transport the sample sheet to a predetermined position of the platform.

3. The pattern identification apparatus as defined in claim 2, wherein the conveying device further including a feeding roller set adapted to separately feed the sample sheet into the pattern identification apparatus.

4. The pattern identification apparatus as defined in claim 1, further comprising a track adapted to sport the illumination device and the video camera unit to a predetermined position in the pattern identification apparatus.

5. The pattern identification apparatus as defined in claim 1, wherein further comprising a substrate mechanically mounted and electrically connected to the programmable identification member.

6. The pattern identification apparatus as defined in claim 1, wherein the platform made of transparent material.

7. The pattern identification apparatus as defined in claim 1, further comprising a switching member for separately sorting the identified sample sheet.

8. The pattern identification apparatus as defined in claim 7, wherein the switching member is able to switch between a first collecting tray and a second collecting tray according to the identification of the programmable identification member; wherein when the programmable identification member determines the true of the sample sheet, the switching member may close the second collecting tray and open the first collecting tray; wherein, contrarily, when the programmable identification member determines the false of the sample sheet, the switching member may close the first collecting tray and open the second collecting tray.

9. The pattern identification apparatus as defined in claim 1, further comprising an inlet and an outlet.

10. The pattern identification apparatus as defined in claim 7, wherein the switching device is pivotally connected to the outlet of the switching device.
